(19) United States
(12) Patent Application Publication
(10) Pub. No.: US 2008/0142559 A1
(43) Pub. Date: Jun. 19, 2008

(54) EXTERNAL BICYCLE RACK INTEGRATED WITHIN A VEHICLE

(76) Inventors: Stephen T. Lim, Farmington Hills, MI (US); Aaron J. Schnepp, Royal Oak, MI (US); Louis A. Rhodes, Farmington Hills, MI (US); Todd McKinzie, Goodrich, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/612,845

(22) Filed: Dec. 19, 2006

(51) Int. Cl. B60R 9/10

(52) U.S. Cl. 224/489

(57) ABSTRACT

The present invention is an integrated external bicycle rack that can be stored quickly and easily within the vehicle when not in use. The bicycle rack can hold up to two bicycles and other objects, and can be equipped on any type of vehicle. In an exemplary embodiment, the bicycle rack includes two support bars which extend rearward of the vehicle from the vehicle's rear frame rail. In another exemplary embodiment, the bicycle rack includes two support bars within a rack frame which is mounted to the vehicle frame, and the two support bars selectively extend rearward of the vehicle. Once the support bars are extended, then one or more load floor panels are relocated from within the vehicle and mounted to the support bars. The load floor panels include attachment device which are used to secure bicycles and the like to the load floor panels.

### FIELD OF THE INVENTION

The present invention relates generally to systems and methods for securing bicycles and other objects to the exterior of a vehicle, and more particularly to an integrated external bicycle rack that can be stored quickly and easily within the vehicle when not in use.

### BACKGROUND OF THE INVENTION

Transporting bicycles and the like with a vehicle requires either disassembling the bicycles for transport within the vehicle or mounting the bicycles external to the vehicle. Disadvantageously, transporting bicycles within the vehicle is limited due to the inconvenience of disassembly of the bicycles and the space constraints within the vehicle. External mounting systems can be placed on the roof of the vehicle, such as a roof rack, or on the rear of the vehicle, such as on a hitch. Roof-based racks are limited due to the inconvenience of mounting the bicycles on the roof and the inability or inconvenience of removing the roof-based rack when not in use. Hitch-based racks are limited due to bicycle space, the inability to access the rear of the vehicle, and the inability or inconvenience of removing the hitch-based rack when not in use.

Adam Opel GmbH, hereinafter Opel, of Rüsselsheim, Germany, provides a retractable bicycle holder integrated in the 2006 model Corsa. The Opel Flex-Fix integrated carrier system provides the ability to carry two bicycles or skis without a separate roof or rear carrier. The Opel integrated carrier system stays hidden behind the rear license plate of the vehicle when not in use. However, the Opel integrate carrier system is limited because it does not allow one bicycle or the like to be secured with the rack only half-deployed and the rear lift-gate on the Corsa cannot be opened when bicycles are strapped to the rack.

### BRIEF SUMMARY OF THE INVENTION

In various exemplary embodiments, the present invention provides an integrated external bicycle rack that can be stored quickly and easily within a vehicle when not in use. The bicycle rack can hold multiple bicycles and other objects, and can be equipped on any type of vehicle including a sedan, hatchback, sport utility vehicle, or the like. In an exemplary embodiment, the integrated external bicycle rack includes two support bars which selectively extend rearward of the vehicle from the vehicle's rear frame rail. In another exemplary embodiment, the integrated external bicycle rack includes two support bars within a rack frame which is mounted to the vehicle frame, and the two support bars selectively extend rearward of the vehicle. The tips of the support bars include rear back-up sensors that operate while the bicycle rack is deployed. Once the support bars are extended, one or more load floor panels are relocated from within the vehicle and mounted to the support bars. The load floor panels include attachment devices which are used to secure bicycles and the like to the load floor panels.

Advantageously, the present invention provides for the integration of the support bars and the load floor panels within the vehicle such that the bicycle rack can be stored quickly and easily when not in use. Also, the present invention supports the placement of one or two bicycles and the like within the same rack. The support bars are selectively deployable half-way for one bicycle or fully extended for two bicycles. Further, the present invention provides integrated back-up sensors within the integrated external bicycle rack that operate while the rack is extended. Additionally, the present invention provides access to the rear interior space of the vehicle while bicycles are loaded on the rack by pivoting the bicycle rack downward with respect to the vehicle. Box or container storage and transport is also contemplated by the present invention.

In an exemplary embodiment of the present invention, an external bicycle rack integrated within a vehicle includes a plurality of support bars configured to selectively deploy from within the rear of the vehicle and a first load floor panel configured to attach to the deployed plurality of support bars, wherein the first load floor panel includes one or more attachment devices to secure an object to the first load floor panel. Preferably, the plurality of support bars are connected to the frame of the vehicle and deploy rearward from within rear frame rails of the vehicle, or the plurality of support bars deploy rearward from within a rack frame which is attached to the frame of the vehicle. Optionally, the load floor panel includes a first and second portion and each portion of the load floor panel is configured to secure an object. The plurality of support bars are configured to selectively deploy in a first position to support the first portion of the load floor panel, and in a second position to support the first and second portion of the load floor panel. Preferably, the plurality of support bars comprise rear back-up sensors located on the distal end of the plurality of support bars, wherein the rear back-up sensors are configured to detect objects behind the vehicle. The bicycle rack includes a pivot point on the plurality of support bars operable to pivot the bicycle rack downwards with respect to the rear of the vehicle to enable access to the rear of the vehicle while the bicycle rack is deployed and securing the object.

In another exemplary embodiment of the present invention, a vehicle with a selectively deployable, integrated external bicycle rack includes a plurality of support bars configured to selectively deploy rearward from within the vehicle and configured to pivot downward with respect to the rear of the vehicle, and a load floor panel configured to connect to the deployed plurality of support bars. The load floor panel is stored within the vehicle when not in use, and includes one or more attachment devices to secure a bicycle to the load floor panel, wherein the rear of the vehicle is accessible while bicycles are attached to the bicycle rack by pivoting the plurality of support bars downward with respect to the vehicle. Preferably, the vehicle includes a rear back-up sensor on the distal end of the plurality of support bars configured to notify a driver of objects in the rear.

In a further exemplary embodiment of the present invention, a method for securing a bicycle to a vehicle with a bicycle rack integrated within the vehicle includes the steps of deploying a plurality of support bars from the rear of the vehicle to a first position, removing a first portion of a load floor panel from the vehicle, placing the first portion of the load floor panel on the plurality of support bars, securing the first portion of the load floor panel to the plurality of support bars, placing an object on the first portion of the load floor panel, and securing the object to the first portion of the load floor panel. The method further includes the steps of deploying the plurality of support bars to a second position, removing a second portion of the load floor panel from the vehicle, placing the second portion of the load floor panel on the plurality of support bars, securing the second portion of the load floor panel on the plurality of support bars, placing a second object on the second portion of the load floor panel, and securing the second object to the second portion of the load floor panel. Optionally, the method further includes the steps of deploying the plurality of support bars to a third position, pivoting the plurality of support bars downward with respect to the vehicle, and accessing the rear of the vehicle.

### BRIEF DESCRIPTION OF THE DRAWINGS

The present invention is illustrated and described herein with reference to the various drawings, in which like reference numbers denote like system components and/or method steps, respectively, and in which:

FIGS. 1a-1i are perspective views illustrating an exemplary embodiment of the integrated external bicycle rack of the present invention in various stages of deployment.

FIGS. 2a-2d are perspective views illustrating another exemplary embodiment of the integrated external bicycle rack of the present invention in various stages of deployment.

FIGS. 3a-3c are a perspective view, a side planar view, and a top planar view, respectively, illustrating a load floor panel for use with the integrated external bicycle racks of FIGS. 1 and 2.

FIGS. 4a-4c are perspective views illustrating an exemplary embodiment of the integrated external bicycle rack of the present accessing the rear interior of a vehicle.

FIG. 5 is a perspective view illustrating an exemplary illustration of the integrated external bicycle rack of the present invention storing and transporting a box or container.

FIGS. 6a-6h are perspective views illustrating a further exemplary embodiment of the integrated external bicycle rack of the present invention.

### DETAILED DESCRIPTION OF THE INVENTION

In various exemplary embodiments, the present invention provides an integrated external bicycle rack that can be stored quickly and easily within a vehicle when not in use. The bicycle rack can hold multiple bicycles and other objects, and can be equipped on any type of vehicle including a sedan, hatchback, sport utility vehicle, or the like. In an exemplary embodiment, the integrated external bicycle rack includes two support bars which selectively extend rearward of the vehicle from the vehicle's rear frame rail. In another exemplary embodiment, the integrated external bicycle rack includes two support bars within a rack frame which is mounted to the vehicle frame, and the two support bars selectively extend rearward of the vehicle. The tips of the support bars include rear back-up sensors that operate while the bicycle rack is deployed. Once the support bars are extended, one or more load floor panels are relocated from within the vehicle and mounted to the support bars. The load floor panels include attachment devices which are used to secure bicycles and the like to the load floor panels.

Advantageously, the present invention provides for the integration of the support bars and the load floor panels within the vehicle such that the bicycle rack can be stored quickly and easily when not in use. Also, the present invention supports the placement of one or two bicycles and the like within the same rack. The support bars are selectively deployable half-way for one bicycle or fully extended for two bicycles. Further, the present invention provides integrated back-up sensors within the integrated external bicycle rack that operate while the rack is extended. Additionally, the present invention provides access to the rear interior space of the vehicle while bicycles are loaded on the rack by pivoting the bicycle rack downward with respect to the vehicle. Box or container storage and transport is also contemplated by the present invention.

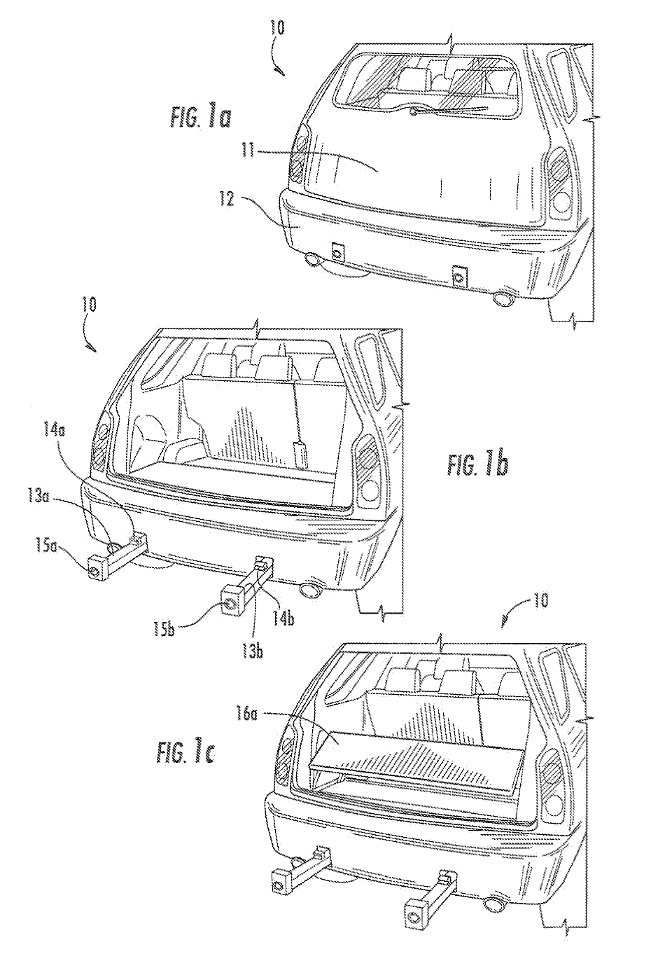

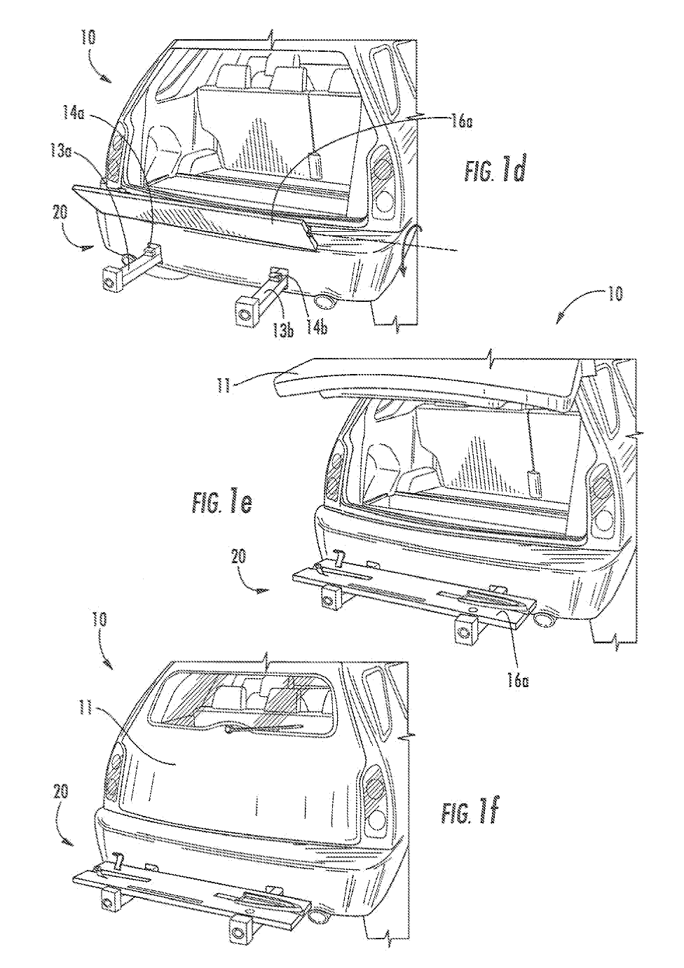

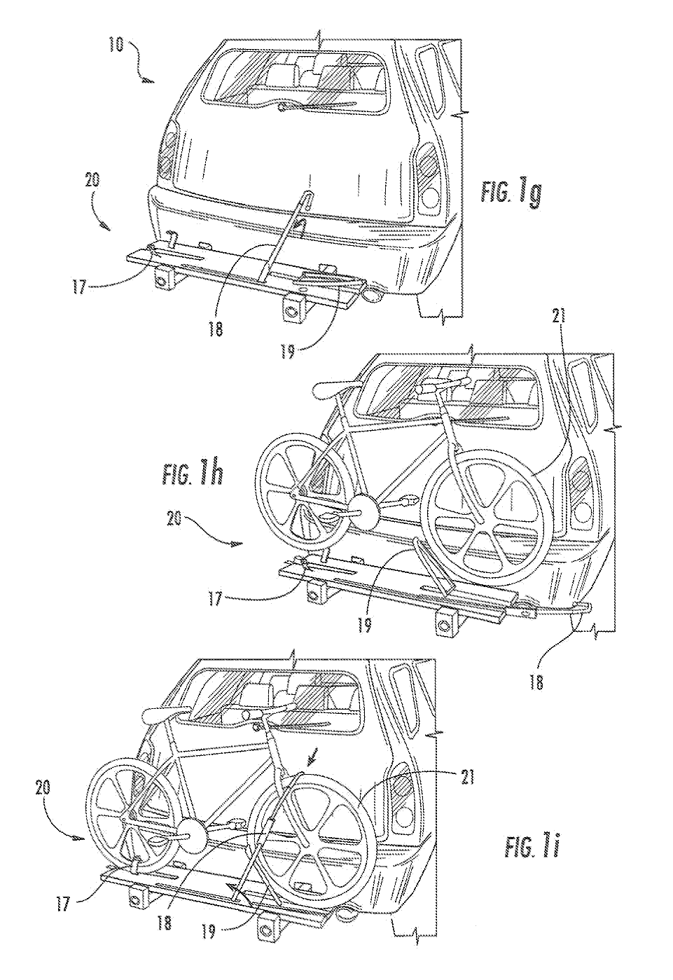

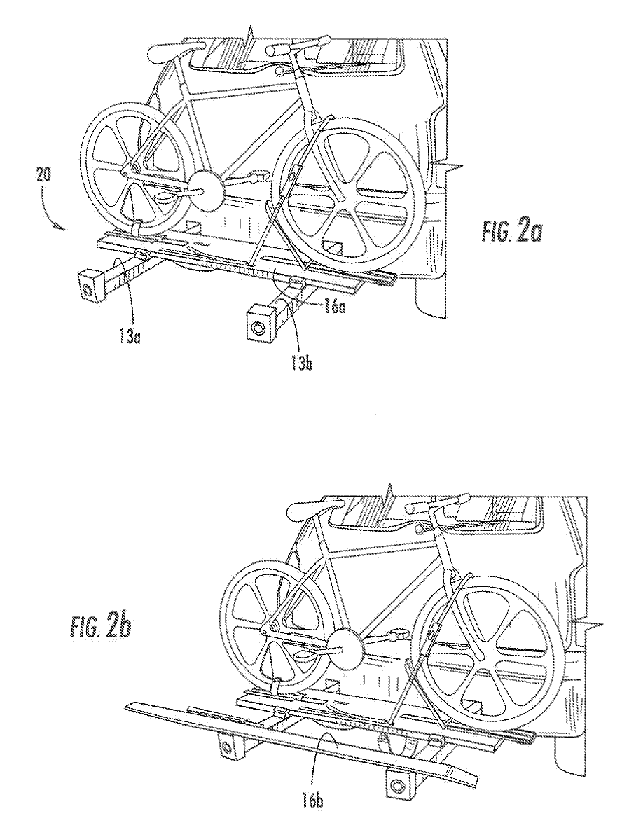

Referring to FIGS. 1a-1i, a vehicle 10 includes an integrated external bicycle rack 20, according to an exemplary embodiment of the present invention. The integrated external bicycle rack 20 is configured to support one or two bicycles or another object with the same hardware. FIGS. 1a-1i illustrate perspective view of the bicycle rack 20 in various stages of deployment in a single-bicycle configuration. The vehicle 10 can be any vehicle such as a hatchback, sedan, sport utility vehicle, truck, or the like. In FIGS. 1a-1i, the vehicle 10 includes a rear lift-gate 11 for access to the rear interior of the vehicle 10.

FIG. 1a illustrates the rear of the vehicle 10 without the integrated bicycle rack deployed and with the rear lift-gate 11 closed. The vehicle 10 includes a rear frame rail 12 which stores selectively deployable support bars. FIG. 1b illustrates support bars 13a and 13b deployed in a position approximately half-way out from within the rear frame rail 12. The rear frame rail 12 includes the interior frame of the vehicle 10 and can include the vehicle's rear bumper as depicted in FIG. 1a.

The support bars 13a and 13b can be deployed automatically through, for example, a motor located inside the rear frame rail 12 operable to extend the support bars 13a and 13b, or manually by, for example, pulling the support bars 13a and 13b outward and utilizing a pin to hold them in place. Further, the support bars 13a and 13b include a locking mechanism which allow the support bars 13a and 13b to either be fully deployed outward for two bicycles, or half-way deployed outward for one bicycle. When not in use, the support bars 13a and 13b are located fully within the vehicle 10 such as inside the rear frame rail 12 or inside the rear compartment of the vehicle 10.

The support bars 13a and 13b include rear back-up sensors 15a and 15b, and tongue/groove mountings 14a and 14b. The rear back-up sensors 15a and 15b are located on the tip at the distal end of the support bars 13a and 13b such that sensors 15a and 15b are operable while the support bars 13a and 13b are deployed. The sensors 15a and 15b are configured to provide detection of objects behind the vehicle 10 when the vehicle 10 is backing up. For example, the sensors 15a and 15b can be configured to provide an audible or visual notification to a driver that an object is close to the vehicle 10 while in reverse.

In the exemplary embodiment of FIG. 1b, a load floor panel is stored in the rear interior of the vehicle 10 when not in use. The load floor panel can be stored in the rear compartment of the vehicle 10. In an exemplary embodiment, the load floor panel forms the interior floor of the vehicle 10 when stored within the vehicle 10. When removed, a secondary floor is over the spare tire in the vehicle 10. This secondary floor can provide increased storage capacity in the rear of the vehicle 10.

As described herein, the lead floor panel refers to a panel that forms a portion of the rear interior of the vehicle 10. It is also contemplated that the load floor panel includes other panels stored in the rear interior of the vehicle 10. One side of the load floor panel is operable to form the rear interior floor of the vehicle 10 and this side can be plastic or rubberized material such as with a honeycomb structure to allow for cleaning. The other side of the load floor panel includes attachment devices as described herein to secure a load such as a bicycle.

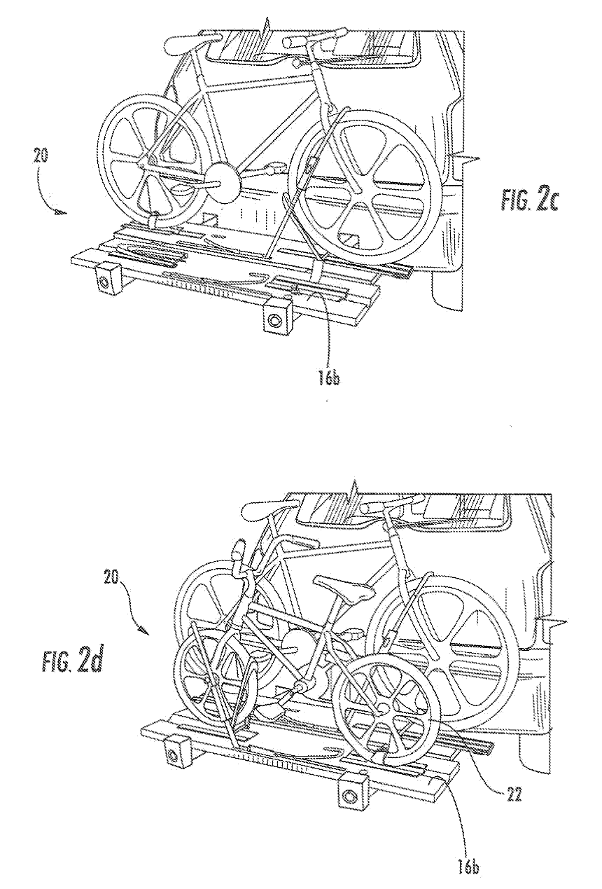

FIG. 1c illustrates removing a first portion of a load floor pane 18a from the rear interior of the vehicle 10. The load floor panel 16a is configured to secure to the support bars 13a and 13b and to hold a load such as a bicycle and other objects. The support bars 13a and 13b can be configured to support one or two floor panels 16a and 16b, as shown further in FIGS. 2a-2d. The load floor panels 16a and 16b can include a first and a second portion of the load floor panel which optionally are halves of a unified load floor panel.

FIG. 1d illustrates removing the load floor panel 16a from the rear interior of the vehicle 10 to place it on the support bars 13a and 13b. For example, the load floor panel 16a can be rotated from the rear interior of the vehicle 10 to place the side of the load floor panel 16a with attachments facing upright. The load floor panel 16a is configured to attach to the support bars 13a and 13b. The forward edge of the load floor panel 16a can be secured to the tongue/groove mountings 14a and 14b on the support bars 13a and 13b. The rear edge of the load floor panel 16a can be secured to the support bars 13a and 13b through a nut and bolt connection (not shown). For example, a nut (e.g., integrated cap screw) can be embedded in the load floor panel 16a and a bolt included in the support bars 13a and 13b. FIG. 1c illustrates the load floor panel 16a attached to the support bars 13a and 13b to form the integrated bicycle rack 20 for securing one bicycle. Once the integrated bicycle rack 20 is deployed, the rear lift-gate 11 is closed as depicted in FIG. 1f.

FIG. 1g illustrates an example of bicycle attachments including a rear tire securing strap 17, a front tire main securing hook 18, and a front tire secondary securing channel 19 on the load floor panel 16a. The bicycle attachments 17, 18, and 19 are secured to one side of the load floor panel 16a and configured to unfold. FIG. 1h illustrates a bicycle 21 placed on the load floor panel 16a of the integrated bicycle rack 20 and attached with the bicycle attachments 17, 18, and 19. The bicycle attachments 17, 18, and 19 are configured with adjustable lengths to support different sized bicycles. For example, the rear tire securing strap 17 can include an adjustable length strap and the front tire main securing hook 18 can extend to different lengths. The front tire secondary securing channel 19 can adjust to varying angles to support the rear of the front tire.

FIG. 1i illustrates the bicycle 21 secured to the integrated bicycle rack 20. The rear tire securing strap 17 is placed around the rear tire of the bicycle 21, the front tire main securing hook 18 is placed around the top of the front tire of the bicycle 21, and the front tire secondary securing channel 19 is placed at the back of the front tire of the bicycle 21. As such, the bicycle 21 is secured to the integrated external bicycle rack 20 and the vehicle 10 can be operated. Advantageously, securing and removing the bicycles is quick and easy with the attachments 17, 18, and 19.

Referring to FIGS. 2a-2d, an integrated external bicycle rack 20 can support two bicycles according to an exemplary embodiment of the present invention. FIGS. 2a-2d illustrate the bicycle rack 20 in various stages of deployment for a two-bicycle configuration. As discussed herein, the bicycle rack 20 can be integrated within any vehicle such as a hatchback, sedan, sport utility vehicle, truck, or the like. FIG. 2a illustrates the bicycle rack 20 deployed with one bicycle loaded on the load floor panel 16a as previously shown in FIG. 1i. The support bars 13a and 13b are configured to extend in a position fully outward from the rear frame rail 12 of the vehicle 10 to support the two bicycle configuration. FIG. 2a illustrates the integrated bicycle rack 20 depicted in FIG. 1a extending the support bars 13a and 13b to the fully outward deployment position.

FIG. 2b illustrates a second portion of a load floor panel 16b being placed on the support bars 13a and 13b extended to a fully deployed length for two bicycles. The load floor panel 16b is placed on the support bars 13a and 13b in a similar fashion as the load floor panel 16a as described in FIGS. 1d-1f. Also, the second portion of the load floor panel 16b can also be stored in the rear interior of the vehicle 10 when not in use. The load floor panel 16b can also have a tongue/groove mounting to connect to the load floor 16a and a nut and bolt connection to connect to the support bars 13a and 13b.

FIG. 2c illustrates the bicycle rack 20 with two load floor panels 16a and 16b connected to the support bars 13a and 13b for carrying two bicycles or other objects. FIG. 2d illustrates adding a second bicycle 22 on the load floor panel 16b. The load floor panel 16b includes the same bicycle attachments 17, 18, and 19 as depicted in FIG. 1g to secure the bicycle 22 to the bicycle rack 20. In the exemplary embodiment of FIG. 2d, the second bicycle 22 is oriented in the opposite position as the first bicycle to maximize packaging space between the bicycles and the rear of the vehicle. Alternatively, the second bicycle 22 can be oriented in the same position as the first bicycle.

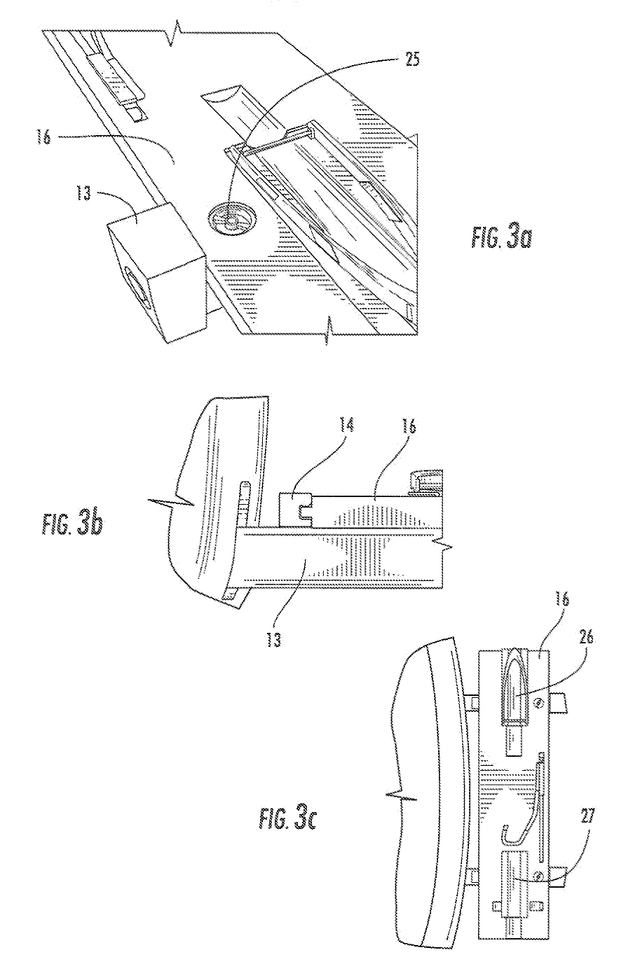

Referring to FIGS. 3a-3c, a load floor 16 can attach and detach quickly and easily from a support bar 13. As discussed in FIGS. 1a-1i and 2a-2d, the load floor panel 16 is stored within the vehicle when not in use, and it can be attached to support bars 13 which are configured to selectively deploy from within the rear frame rail of the vehicle. In one exemplary embodiment, a bicycle rack can support one or tow load floor panels 16a and 16b to support one or two bicycles, respectively. In the case of two load floor panels 16a and 16b, each load floor panel 16 is a separate panel which is stored inside the vehicle and which is mounted to the support bars 13. As discussed herein, the load floor panels 16a and 16b can include a first and a second portion of the load floor panel which optionally are halves of a unified load floor panel.

FIG. 3a illustrates the mounting of the load floor panel 16 to the support bar 13 with a connection 25. The connection 25 can include an integrated cap that screws around bolts that are fixed to the support bar 13 or an integrated cap that includes a screw which screws into a hole in the support bar 13. Alternatively, the integrated cap can include a screw which fits into a hole in the support bar 13. The integrated cap is included in the load floor panel 16 and is similar to what is used to secure a spare tire within a spare tire hub in a vehicle. Advantageously, this embodiment provides a quick and easy connection and ensures that screws and bolts are not misplaced. Further, the integrated cap does not extend beyond the load floor panel 16 on the attachment side, avoiding any interference with the bicycles or the load. Additionally, the connection 25 can include any other means such as a stand-alone screw and bolt to connect the load floor panel 16 to the support bar 13. In an exemplary embodiment of the present invention, the connection 25 is located on the rear portion on the load floor panel 16 with the forward portion utilizing a tongue/groove mounting to connect to the support bar 13.

FIG. 3b illustrates the forward portion of the load floor panel 16 and a tongue/groove mounting 14 to connect the load floor 16 to the support bar 13. The load floor panel 16 is configured on one side with a groove operable to fit into the tongue/groove mounting 14 on the support bar 13. Also, the load floor panel 16 can be configured with a tongue on the other side to allow a second load floor panel 16 to connect to it. Alternatively, the support bar 13 can be configured to have two tongue/groove mountings 14 to support two load floors 14 in a two-bicycle configuration.

FIG. 3c illustrates channels 26 and 27 on the load floor 16 for accommodating different size bicycle wheelbases. The channels 26 and 27 can be configured to slide to varying lengths on the load floor panel 16 as needed for the bicycle size. Advantageously, this allows transport of different size bicycles without the requirement to remove a bicycle's wheel when securing the bicycle to the bicycle rack.

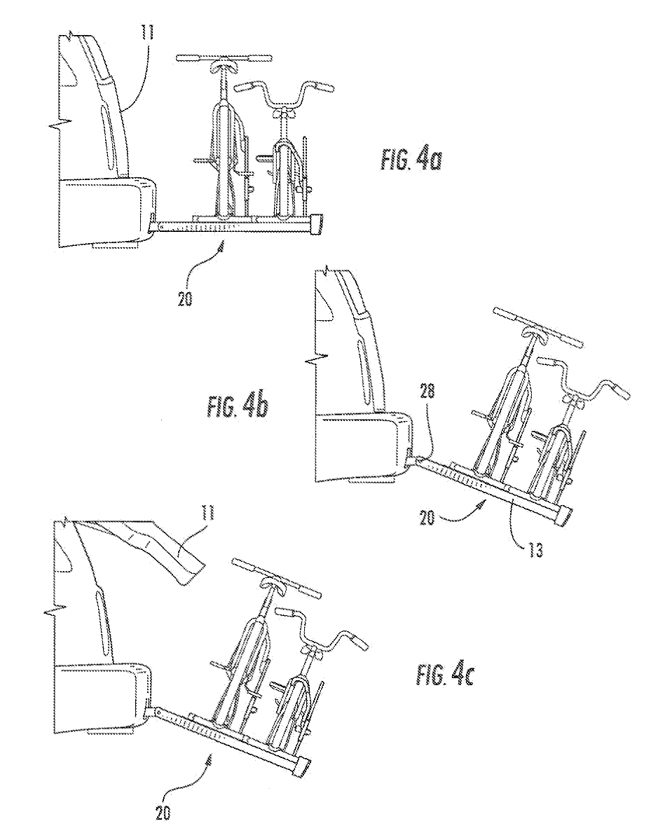

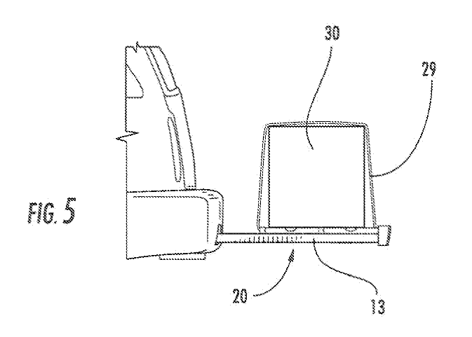

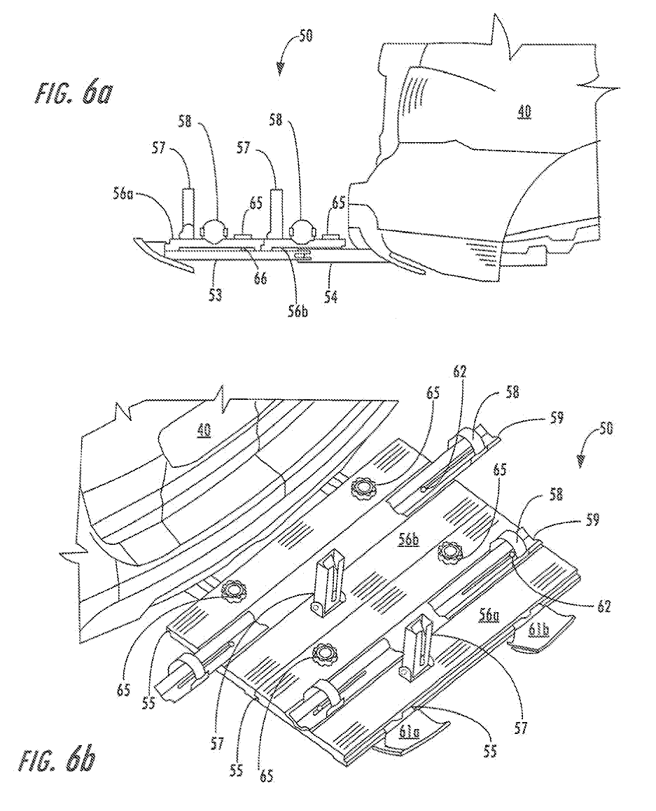

Referring to FIGS. 4a-4c, an integrated external bicycle rack 20 can support up to two bicycles while allowing access to the rear interior of the vehicle through a rear lift-gate 11, according to an exemplary embodiment of the present invention. FIG. 4a illustrates the bicycle rack 20 with two bicycles loaded and the rear lift-gate 11 closed in the back of the vehicle. FIG. 4b illustrates a pivot point 28 configured to allow the support bars 13 of the bicycle rack 20 in pivot downward allowing access to the rear lift-gate 11. The pivot point 28 is at the proximal end of the support bars 13. The support bars 13 are configured to rotate downward about the point pivot 28. The pivot point 28 can include a locking pivot mechanism, ball-bearing pivot, collar pivot mechanism, or the like. FIG. 4c illustrates opening the rear lift-gate 11 with the bicycle rack 20 pivoted downward. Advantageously, the pivot point 28 allows the bicycle rack 20 to be deployed and loaded without losing access to the rear of the vehicle. The pivot point 28 can include a locking mechanism to prevent the support bars 13 from moving. For example, a locking pin can be used on the support bars 13 to prevent the pivot point 28 from moving, and removed to allow the rack 20 to pivot downward for access to the vehicle 10.

Referring to FIG. 5, the bicycle rack 20 of the present invention can also have alternate uses such as storing and transporting a load 30. Here, the load 30 is loaded on the support bars 13 of the bicycle rack 20 instead of bicycles. Examples of loads 30 can include a cooler, a television, boxes, containers, or the like. Additionally, the support bars 13 can support a connection to allow a strap 29 to secure the load 30 to the support bars 13 to prevent movement during transport of the vehicle.

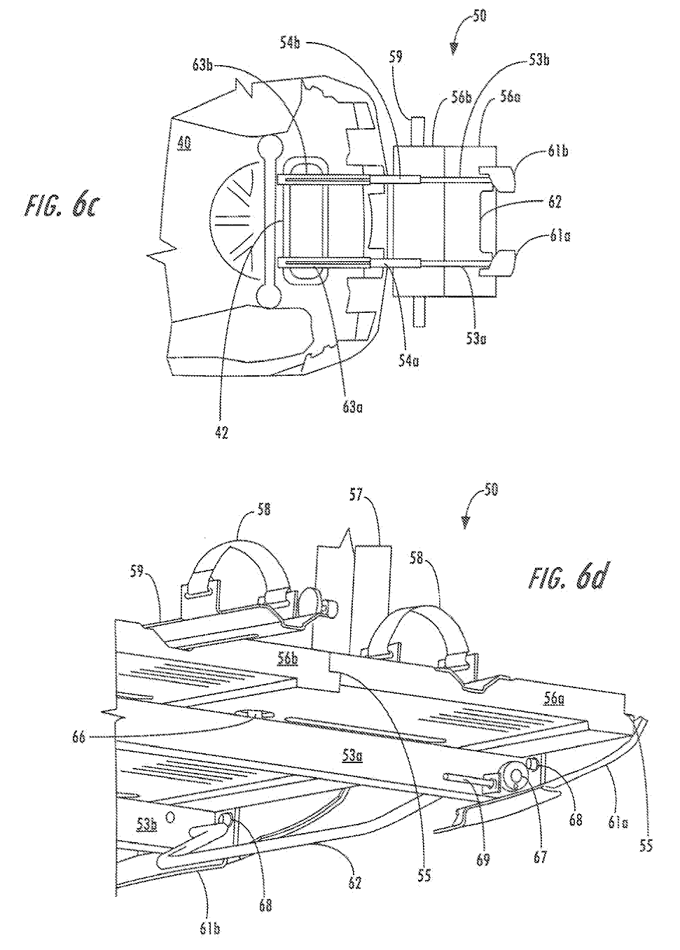

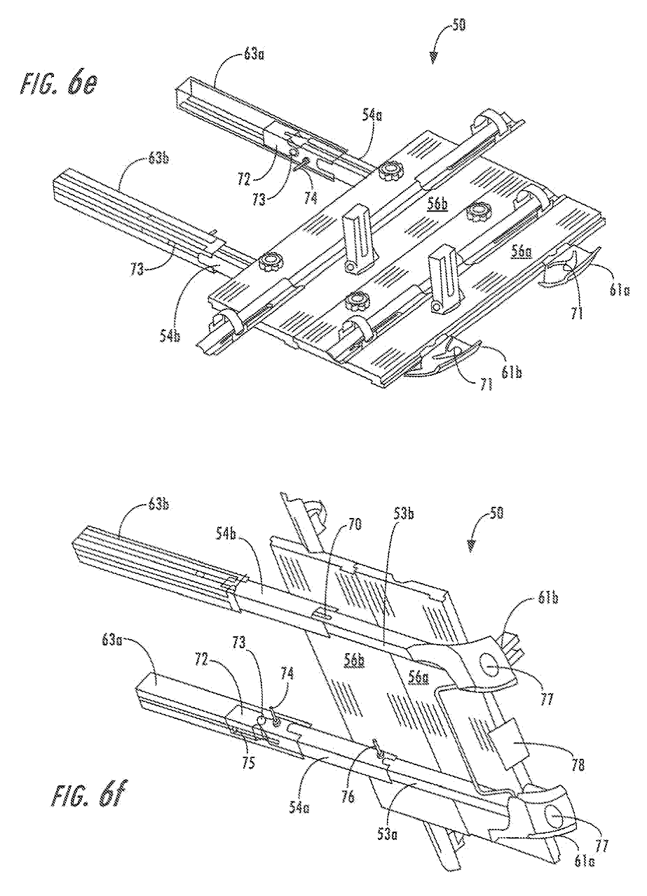

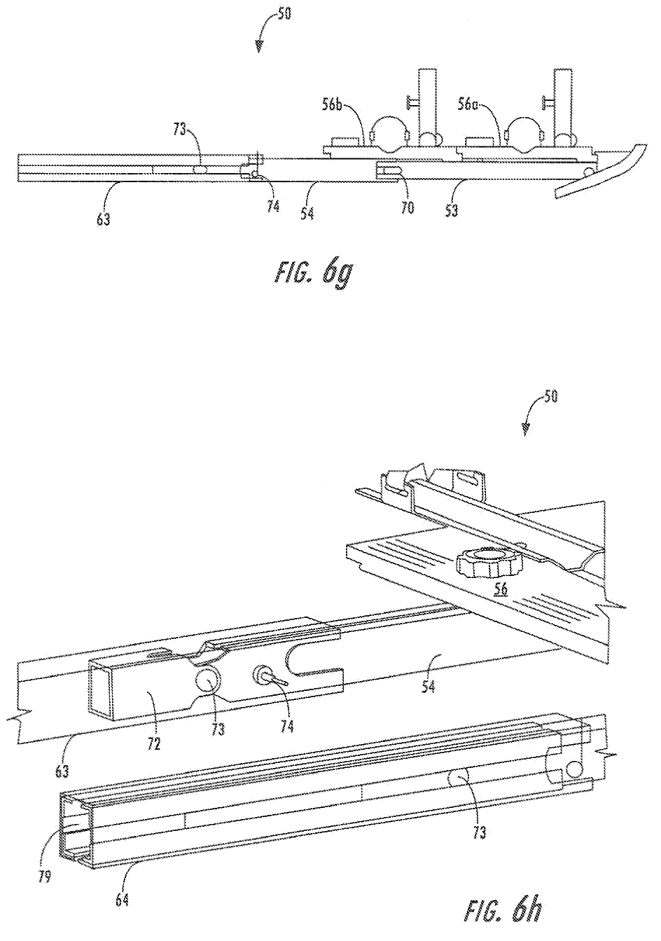

Referring to FIGS. 6a-6h, a vehicle 40 includes an integrated external bicycle rack 50, according to a further exemplary embodiment of the present invention. The integrated external bicycle rack 50 is configured to support one or two bicycles with the same hardware, and FIGS. 6a-6h illustrate various perspective view of the integrated external bicycle rack 50 configured to support two bicycles. The vehicle 40 can include any vehicle such as a hatchback, sedan, sport utility vehicle, truck, or the like.

FIG. 6a illustrates a side perspective view of the integrated external bicycle rack 50. The bicycle rack 50 includes support bars 53 in the deployed position and two portions 56a and 56b of a load floor panel. The support bars 53 are located within rails 54, and both the support bars 53 and the rails 54 selectively deploy from the rear of the vehicle 40. The portions 56a and 56b of the load floor panel are secured to the support bars 53 with an integrated cap 65 which screws into the support bars 53 with a screw 66. The portions 56a and 56b fit together through a tongue and groove connection which holds the portions 56a and 56b together where they meet, and holds the first portion 56a to the support bars 53 at the distal end of the support bars 53.

As discussed herein, the portions 56a and 56b of the load floor panel can be stored in the rear interior of the vehicle 40 when not in use. The load floor panel can be stored in the rear compartment of the vehicle 40. In an exemplary embodiment, the load floor panel forms the interior floor of the vehicle 40 when stored within the vehicle 40. When removed, a secondary floor is over the spare tire in the vehicle 40. This secondary floor can provide increased storage capacity in the rear of the vehicle 40.

Each portion 56a and 56b of the load floor panel includes attachment devices to secure a bicycle. The attachment devices can include stem holders 57 and wheel straps 58. The load floor panel can include any type of attachment device to secure a load such as a bicycle. The stem holders 57 and wheel straps 58 allow a quick and easy attachment and detachment of a bicycle from the portions 56a and 56b. The stem holder 57 is configured to secure the center frame of a bicycle in place. The stem holder 57 is also configured to rotate on the portions 56a and 56b to lay flat while the portions 56a and 56b are stored in the vehicle 40. The wheel straps 58 are configured to secure the wheels of the bicycle with adjustable length straps. Advantageously, the attachment device 57 and 58 allow a bicycle to be secured and transported without requiring disassembly of the bicycle.

FIG. 6b illustrates a top diagonal perspective view of the integrated external bicycle rack 50. Each portion 56a and 56b includes bicycle attachments to quickly and easily secure a bicycle to the portion. The stem holder 57 includes a slot to lower the center frame of a bicycle into the holder 57 and a clip to hold the center frame in place. Also, the stem holder 57 includes a pivot to allow the holder 57 to rotate and fold down when the portion 56a and 56b of the load floor panel is stored in the vehicle 40. The wheel straps 58 are attached to channels 59. The channels 59 fit within grooves on the portions 56a and 56b of the load floor panel and are configured to slide to varying lengths to accommodate different size bicycles. The channels 59 are locked in place once adjusted by a screw 62, and the screw 62 can be loosened to further adjust the channel 59 length.

Two integrated caps 65 are located on each portion 56a and 56b of the load floor panel to secure the portions 56a and 56b to the support bars 53. Each portion of the load floor panel includes a tongue and groove 55 on both ends. Advantageously, this allows either of the portions 56a and 56b to be placed first or second on the support bars 53. The ends 61a and 61b of the support bars 53 include a groove connection to secure to the tongue and groove 55 on the portion 56a. The ends 61a and 61b are configured to store within the rear of the vehicle 40 such as, for example, in the rear bumper of the vehicle 40. Additionally, the ends 61a and 61b of the support bars 53 can include back up sensors (not shown) as described herein.

FIG. 6c illustrates a bottom perspective view of the integrated external bicycle rack 50 attached to a rear frame 42 of the vehicle 40. In the exemplary embodiment, rack frames 63a and 63b are mounted to the rear frame 42. Here, the bicycle rack 50 includes its own frame 63a and 63b separate from the frame 42 of the vehicle 40. Advantageously, this allows the same bicycle rack 50 to be mounted on different vehicles without major frame modifications to each vehicle. However, the bicycle rack 50 is still integrated within the vehicle 40 and the support bars 53a and 53b are configured to selectively deploy from within the vehicle 40.

The rack frame 63a and 63b is configured to selectively deploy rails 54a and 54b and support bars 53a and 53b from the rear of vehicle 40. The support bars 53a and 53b are configured to slide from within the rails 54a and 54b. The support bars 53a and 53b can be locked in a first position to support one portion 56b for a single bicycle or in a second position to support both portions 56a and 56b for two bicycles. The rails 54a and 54b can be locked in a first position for extension of the support bars 53a and 53b and in a second position to extend a pivot point out of the rack frames 63a and 63b for rotating the bicycle rack 50 downward. In this exemplary embodiment, the support bars 53a and 53b are connected with a bar 62 at the ends 61a and 61b. The bar 62 can be used to manually deploy the support bars 53a and 53b and the rails 54a and 54b from within the vehicle 40. Alternatively, the support bars 53a and 53b and the rails 54a and 54b can be automatically deployed through a motor or the like. Also, the channel 59 is illustrated extending from the portion 56b in a position to store a larger bicycle.

FIG. 6d illustrates a close-up perspective view of the integrated external bicycle rack 50. As described herein, the portions 56a and 56b of the load floor panel secure to one another with a tongue and groove 55 mounting, and connect to the support bars 53a and 53b through a screw 66 and integrated cap on the top of the portions 56a,56b. the bar 62 connects the two support bars 53a and 53b and is connected to the support bars with a connection 67 which allows the bar 62 to swivel. For example, the bar 62 can swivel outward to allow a person to manually deploy the support bars 53a and 53b and the rails 54a and 54b.

The ends 61a and 61b connect to the support 53a and 53b with a bolt connection 68. In manufacturing, different ends 61a and 61b can be used depending on the vehicle type. For example, the shape and color of the ends 61a and 61b can be changed depending on the rear of the vehicle. This allows the same bicycle rack 50 to be deployed on different vehicles without a custom design for each vehicle. The present invention is intended to be integrated within a vehicle in manufacturing or in the after-market by a dealer. With a separate frame 63a and 63b and the ability to modify the ends 61a and 61b of the support bars 53a and 53b, the same bicycle rack 50 design can be used on several different vehicle types in manufacturing.

A lock 69 is located on the ends 61a and 61b of the support bars 53a and 53b and is configured to secure the support bars 53a and 53b in place within the rails 54a and 54b and the frame 63a and 63b. FIG. 6d also shows the attachments in detail. The stem holder 57 includes a knob to adjust the height of the stem holder 57 and to lock the frame of a bicycle in place. The channel 59 includes an adjustable strap 68 to secure the wheel of the bicycle.

FIG. 6e illustrates a perspective top view of the integrated external bicycle rack 50 with one rack frame 63a shown transparently. The rails 54a and 54b slide within the rack frames 63a and 63b on rails or the like. The rails 54a and 54b include an extension 72 which connects through a hinge 73 such as a bolt or the like. A pin 74 prevents the extension 72 from extending out of the frames 63a and 63b, and can be removed to allow the extension 72 to deploy outward. The pin 74 is placed in position to support both portions 56a and 56b of the load floor panel for two bicycles. The pin 74 can also be positioned to support one portion 56a for a single bicycle (not shown). Once out of the rails 63a and 63b, the extension 72 and hinge 73 are configured to allow the entire bicycle rack 50 to rotate downward. Advantageously, this allows access to the rear interior of a vehicle with bicycles secured to the rack 50. In an exemplary embodiment, the extension 72 allows the bicycle rack 50 to extend approximately 30″ outward. Additionally, handles 71 are located on the ends 61a and 61b can be deployed to expose the handles 71 which can be used to manually deploy the support bars 53a and 53b and the rails 54a and 54b in position for one or two bicycles or in position to expose the extension 72 to pivot the rack 50.

FIG. 6f illustrates a perspective bottom view of the integrated external bicycle rack 50 with one rack frame 63a shown transparently. The support bars 53a and 53b are configured to deploy from the rails 54a and 54b, and they are prevented from coming out of the rails by a groove 70. The support bars 53a and 53b slide within the rails 54a and 54b in the groove 70. The support bars 53a and 53b are locked in position in the rails 54a and 54b with a pin 76. The pin 76 can lock in two positions in the rails 54a and 54b with the first position supporting one portion 56 of the load floor panel for one bicycle (not shown) and the second position supporting both portions 56a and 56b of the load floor panel for two bicycles. Additionally, FIG. 6f illustrates rear back-up sensors 77 on the ends 61a and 61b of the support bars 53a and 53b for providing object detection while the vehicle is in reverse. Also, the distal end of the bicycle rack 50 can include a license plate 78 connected to either the portion 56a of the load floor panel or through a bar connected between the support bars 53a and 53b.

FIG. 6g illustrates a side perspective view of the integrated external bicycle rack 50. The support bar 53 is extended to support two portions 56a and 56b of the load floor panel and locked to the rail 54 in a second position. The pin 76 is located on the opposite side of the support bar 53, and is not visible in this figure. The rail 54 is extended from the rack frame 63 and locked with pin 74. The hinge 73 is shown inside the rack frame 63.

FIG. 6h illustrates a transparent perspective view of the rack frame 63 showing the pivoting mechanism and grooves 79 for sliding the rails 54 in the rack frame 63. The extension 72 connects to the rail 54 through a hinge 73 which is configured to allow the rail 54 to rotate about the extension 72. The extension 72 is secured within the rack frame 63 by a pin 74 which can be removed to allow the hinge 73 to be deployed out of the rack frame 63 with the extension 72 remaining within the rack frame 63. Both the extension 72 and rail 54 are configured to slide within the rack frame 63 on a groove 79.

Although the present invention has been illustrated and described herein with reference to preferred embodiments and specific examples thereof, it will be readily apparent to those of ordinary skill in the art that other embodiments and example may perform similar functions and/or achieve like results. All such equivalent embodiments and examples are within the spirit and scope of the present invention and are intended to be covered by the following claims.

What is claimed is:

1. An external bicycle rack integrated within a vehicle comprising:
a plurality of support bars configured to selectively deploy from within the rear of the vehicle; and
a first load floor panel configured to attach to the deployed plurality of support bars, wherein the first load floor panel comprises one or more attachment devices to secure an object to the first load floor panel.

2. The external bicycle rack integrated within a vehicle of claim 1, wherein the plurality of support bars are connected to the frame of the vehicle and deploy rearward from within rear frame rails of the vehicle.

3. The external bicycle rack integrated within a vehicle of claim 1, wherein the plurality of support bars deploy rearward from within a rack frame, and wherein the rack frame is attached to the frame of the vehicle.

4. The external bicycle rack integrated within a vehicle of claim 1, wherein the forward edge of the load floor panel connects to the plurality of support bars through a tongue/groove mounting, and wherein the rear edge of the load floor panel connects to the plurality of support bars through an integrated cap on the load floor panel that is configured to screw into the plurality of support bars.

5. The external bicycle rack integrated within a vehicle of claim 1, wherein the rear edge of the load floor panel connects to the plurality of support bars through a tongue/groove mounting, and wherein the forward edge of the load floor panel connects to the plurality of support bars through an integrated cap on the load floor panel that is configured to screw into the plurality of support bars.

6. The external bicycle rack integrated within a vehicle of claim 1, wherein the load floor panel comprises a first and second portion and each portion of the load floor panel is configured to secure an object.

7. The external bicycle rack integrated within a vehicle of claim 6, wherein the plurality of support bars are configure to selectively deploy in a first position to support the first portion of the load floor panel.

8. The external bicycle rack integrated within a vehicle of claim 6, wherein the plurality of support bars are configured to selectively deploy in a second position to support the first and second portion of the load floor panel.

9. The external bicycle rack integrated within a vehicle of claim 1, wherein the one or more attachment devices comprise a rear tire securing strap, a front tire main securing hook, and a front tire secondary securing channel.

10. The external bicycle rack integrated within a vehicle of claim 1, wherein the one or more attachment devices comprise a stem holder and wheel straps.

11. The external bicycle rack integrated within a vehicle of claim 1, wherein the plurality of support bars comprise rear back-up sensors located on the distal end of the plurality of support bars, wherein the rear back-up sensors are configured to detect objects behind the vehicle.

12. The external bicycle rack integrated within a vehicle of claim 1, wherein the bicycle rack comprises a pivot point on the plurality of support bars operable to pivot the bicycle rack downwards with respect to the rear of the vehicle to enable access to the rear of the vehicle while the bicycle rack is deployed and securing the object.

13. The external bicycle rack integrated within a vehicle of claim 12, wherein the pivot point comprises a hinge connected to an extension, and wherein the hinge and extension are within a rack frame and are selectively deployed to allow pivoting of the bicycle rack.

14. The external bicycle rack integrated within a vehicle of claim 1, wherein the plurality of support bars are configured to manually deploy to a first position for securing one object, to a second position for securing two objects, and to a third position for pivoting the bicycle rack downward with respect to the rear of the vehicle.

15. The external bicycle rack integrated within a vehicle of claim 1, wherein the bicycle rack is configured to secure a box or container, wherein the box or container is secured to the plurality of support bars with a strap.

16. A vehicle with a selectively deployable, integrated external bicycle rack comprising:
a plurality of support bars configured to selectively deploy rearward from within the vehicle and configured to pivot downward with respect to the rear of the vehicle; and
a load floor panel configured to connect to the deployed plurality of support bars, wherein the load floor panel is stored within the vehicle when not in use and wherein the load floor panel comprises one or more attachment devices to secure a bicycle to the load floor panel;
wherein the rear of the vehicle is accessible while bicycles are attached to the bicycle rack by pivoting the plurality of support bars downward with respect to the vehicle.

17. The vehicle with a selectively deployable, integrated external bicycle rack of claim 16, wherein the vehicle comprises a rear back-up sensor on the distal end of the plurality of support bars configured to notify a driver of objects in the rear.

18. A method for securing a bicycle to a vehicle with a bicycle rack integrated within the vehicle comprising the steps of:
deploying a plurality of support bars from the rear of the vehicle to a first position;
removing a first portion of a load floor panel from the vehicle;
placing the first portion of the load floor panel on the plurality of support bars;
securing the first portion of the load floor panel to the plurality of support bars;
placing an object on the first portion of the load floor panel; and
securing the object to the first portion of the load floor panel.

19. The method of claim 19 further comprising the steps of:
deploying the plurality of support bars to a second position;
removing second portion of the load floor panel from the vehicle;
placing the second portion of the load floor panel on the plurality of support bars;
securing the second portion of the load floor panel on the plurality of support bars;
placing a second object on the second portion of the load floor panel; and
securing the second object to the second portion of the load floor panel.

20. The method of claim 19 further comprising the steps of:
deploying the plurality of support bars to a third position;
pivoting the plurality of support bars downward with respect to the vehicle; and
accessing the rear of the vehicle.
